(19) United States
(12) Patent Application Publication
(10) Pub. No.: US 2024/0419856 A1
(43) Pub. Date: Dec. 19, 2024

(54) SYSTEMS AND/OR METHODS FOR PREDICTING AND/OR ADDRESSING FAILURES IN ENGINEERED AND/OR COMPOSITE WOOD PRODUCTS

(71) Applicant: Bakelite UK Holding Ltd., Sully (GB)

(72) Inventors: Robert Arnold BREYER, Decatur, GA (US); Melissa CANNON, Decatur, GA (US); Jessica JENNINGS, Decatur, GA (US); Dirk KILLEN, Decatur, GA (US); Jeff OTJEN, Decatur, GA (US); Alex D. Muzzillo, Decatur, GA (US)

(21) Appl. No.: 18/209,139

(22) Filed: Jun. 13, 2023

(51) Int. Cl. G06F 30/20

(52) U.S. Cl. CPC G06F 30/20; B27D 1/04; G06F 2111/10

(57) ABSTRACT

Certain example embodiments model wood product production, including composite wood production such as, for example, plywood. Data is received for different factors, with first and second factors being moisture content distributions for face and core veneers. A first model is developed to model moisture content as a function of at least some of the factors. First and second effects on first and second results of interest are determined based on output from the first model being provided to a second model. First and second curves representing first and second aspects of the production are created based on output from the second model. The first and second result of interest are high and low moisture content related errors, and the first and second curves are indicative of first and second areas where high and low moisture content related errors are to be expected based on first and second sets of conditions.

### TECHNICAL FIELD

Certain example embodiments described herein relate to wood products including, for example, engineered and/or composite wood products. More particularly, certain example embodiments described herein relate to techniques for predicting, and/or suggesting process parameter changes to address, failures in wood product manufacturing.

### BACKGROUND AND SUMMARY

Engineered and composite wood products include, for example, plywood, laminated veneer lumber (LVL), oriented strand board (OSB), particle board, medium-density fiberboard (MDF), cross-laminated timber (CLT), etc. These products are used in a wide variety of projects such as, for example, sub-floors and flooring, support beams in residential and commercial buildings, cabinets and shelving, home and office furniture, and so on.

Techniques for creating these and other engineered and composite wood products are known. For example, and in brief, plywood is made using multiple veneer sheets that are glued together in layers to form intermediate products that are compressed and cut to size. In some cases, the face and backing sheets may be formed from the same wood as, or different wood from, the inner or “core” sheet(s). For instance, in some cases, birch face and backing sheets may be glued to one or more yellow poplar strips used as the “inside” of the plywood. In other cases, pine may be used for each of the veneers in a three-veneer plywood product. Other configurations of these and/or other wood species also are known.

Referring to the manufacturing process for plywood in greater detail, trees that provide the wood for the veneers are brought in on trucks where they are sorted, trimmed, and soaked in a caustic liquid that helps to improve the milling process. The wet, trimmed tree trunks are sent through a lathe, where they are debarked and where thin sheets are removed at predetermined thicknesses for use as the veneers. Veneers are graded and sorted by grade. Typical veneer thicknesses are 1/10″ to ⅙″ (e.g., ⅛″). The veneers also may be sorted by type, which in this case refers to where in the tree trunk the wood came from (e.g., an inner part or an outer part of the tree trunk).

The veneers are dried (typically to achieve a moisture content range of 3-25% at approximately 230-450 degrees fahrenheit), and the dried veneers come out of the dryer at an elevated temperature (typically over 130 degrees fahrenheit). The veneers are once again sorted. Different veneers are bonded together using a resin or other adhesive or “glue” material, which is applied using a glue spreader or the like. The glue is applied to at least some of the veneers, which are stacked together in a grain pattern, e.g., with 3, 4, 5, 7, or any other appropriate number of veneers. With respect to the grain pattern typically used, the veneers typically are oriented such that the grains in adjacent veneer layers are generally perpendicular to one another. As one example, a double-roll coater may apply a urea formaldehyde glue to “every other” veneer that makes up the plywood product, e.g., when an odd number of veneers is used. Heat is applied to activate the glue material, and the intermediate product ultimately is cut to size. The layered and glued veneers are compressed using a cold press and then a hot press to help ensure a good bond. The cold press may operate at about 120-160 pounds of pressure (in psi) for 15 minutes, and the hot press may operate at about 170-190 pounds of pressure (in psi) at 270-350 degrees fahrenheit for plywood, while for other products the temperature can be up to 425 degrees fahrenheit or possibly even higher. In the cutting operation, for instance, 50″×100″ panels may be cut down precisely to 48″×96″ or 48″×48″ panels within a narrow tolerance (e.g., 1/64″). The laminated product is sanded to remove a very small amount of material.

Throughout the process, moisture meters may be used to guide manufacturers as to when wet trunks and/or veneers need to be redried or set down for a set-down period in which they can equilibrate with respect to moisture content. Grading of sheets to be used as face and/or back sheets typically is performed manually by a human in connection with the sorting, e.g., using a set rubric with a predetermined number of grades, or by an automated computer grading system.

As will be appreciated from the prior paragraph, in plywood and other wood products, in many instances much of the grading work is done “by hand” by human operators. Behind such manual processes are yet further processes that are decided by humans, largely by trial-and-error. For example, when manufacturing plywood and other wood products, the levels of acceptable veneer moistures, dryer and hot press temperatures, and other process parameters typically are decided by trial-and-error over a period of time based on actual production output. Different grades, and the criteria for distinguishing between such grades, also typically are decided by trial-and-error over a period of time based on actual production output. Mills typically implement “what works” to achieve a target output reject percentage. And these process parameters are typically maintained until they “do not work” anymore (e.g., an output reject percentage exceeds a target), at which point process parameters are modified by further trial-and-error approaches.

Although there are some current computerized tools in use that help automate surface imperfection detection, it would be desirable to improve such tools and/or to provide new tools that help to reduce and possibly even eliminate manual processes and threshold-setting by trial-and-error. Similarly, it would be desirable to improve such tools and/or to provide new tools that help to be able to model what effect(s) a process parameter change might have on overall yield and/or output from a particular processing operation used in the overall manufacturing process. For example, it would be desirable to model what effect(s) changing moisture thresholds would have on dryer operation and press throughput. Indeed, it would be desirable to model these effects in terms of effects on yield, energy consumption, product waste, and/or the like.

Certain example embodiments help address the above-described and/or other concerns. For instance, certain example embodiments relate to a Bayesian statistical modelling approach that helps to design and modify wood product construction parameters and procedures, e.g., to reduce the amount of energy used and/or to reduce the amount of reject materials, while improving production of such products.

Certain example embodiments provide technical advantages in terms of improving existing inspection tools by providing such tools with new capabilities, for example, to model what effect(s) process and/or process parameter changes might cause, while also anticipating when, where, and how errors might occur. For example, certain example embodiments enable such tools to design and optimize construction and pressing conditions for wood products (including plywood) to help optimize dryer production and press throughput.

Certain example embodiments provide for a series of steps that improve upon existing manual processes in the technical area of the creation of wood products, including engineered and/or composite wood products. Such formalized steps implemented as described herein provide for a technical improvement of prior processes, including those that are manual or semi-manual in nature.

One aspect of certain example embodiments relates to a tool that enables a wood product's manufacturing parameters to be designed so that an optimized moisture can be used to help a mill more efficiently use their dryers while also reducing the number of reject products. Additional factors like press conditions can be added into the model because the moisture content can directly affect the flow of heat in the product being manufactured. Understanding and optimizing these and/or other process parameters can result in more efficient pressing by reducing time and/or energy requirements for the manufacturing, e.g., as dryers tend to be a major bottleneck during manufacturing and a major source of energy consumption. The use of a living Bayesian model is employed in certain example embodiments, which is advantageous because it can help to provide a high predictive capability and the ability to add factors into the model, e.g., while producing simple and understandable outputs (e.g., a simple YES/NO indication with an associated probability of an effect of interest, given one or more specified conditions). Further, the use of a living model (e.g., a model that changes as new data is added, with that new data being used to augment the old model rather than just replacing it) advantageously can in certain example embodiments reduce computational time and requirements relative to other types of models. Also advantageously, because a Bayesian approach treats parameters as numbers with a distribution, it becomes possible to predict expected performance ranges, thereby providing a platform for differentiating between natural and non-natural variations in products produced.

One existing approach to diagnosing problems including “blows” in plywood (where voids cause delamination of veneer strips) involves a post hoc test where a panel is cut open and examined. In some cases, acoustic detectors may be used to listen for variations that might indicate the presence of a void that could lead to these blows. These tests unfortunately may come too late, in the sense that many panels may be constructed with such problems being present or being likely to be present. Certain example embodiments help address this issue by providing a set of operating parameters that, when used, are likely (or more likely than not) to create products where such problems do not occur (or where such problems occur at a lower and/or more predictable rate). Indeed, certain example embodiments help with the tuning of operating parameters using a population analysis approach, where it is possible to make decisions based on attributes of the population and to adjust parameters even before veneers are glued together because moisture content can be managed more effectively and efficaciously based on this added intelligence.

In certain example embodiments, there is provided a method for modelling outcomes related to a modelled attribute of composite and/or engineered wood products being produced. Data is received for a plurality of factors, with at least some of the factors having a numerical distribution of values. Based on the received data, a first model that produces a distribution modelling the attribute of the wood products being produced as a function of at least some of the factors in the plurality of factors is developed. Outcomes related to the modelled attribute are predicted using outputs from the first model and a second model, with the first and second models being different from one another. A first distribution of values is defined for the modelled attribute where the predicted outcomes match a first defined outcome with at least a first threshold probability.

According to certain example embodiments, a second distribution of values may be defined for the modelled attribute where the predicted outcomes match a second defined outcome with at least a second threshold probability, with the first and second defined outcomes indicating unacceptable outcomes that are different from one another, e.g., with the first and second distributions of values defining a space therebetween representing acceptable outcomes.

According to certain example embodiments, data relevant to the manufacture of wood products may be gathered at a mill where the wood products are being produced; at least the gathered data may be provided to the first model to determine an overall moisture content related distribution; and the mill's performance may be modelled using the overall moisture content related distribution and the first distribution of values, e.g., where the first distribution of values at least partially defines an area where a moisture content related error is to be expected.

According to certain example embodiments, data indicative of at least one prospective process parameter change for the manufacture of wood products at a mill where the wood products are being produced may be received; at least the received data may be provided to the first model to determine an expected overall moisture content related distribution for the mill; and the expected mill performance may be modelled using the expected overall moisture content related distribution and the first distribution of values, e.g., with the first distribution of values at least partially defining an area where a moisture content related error is to be expected.

In certain example embodiments, a method for modelling plywood production is provided. Data for a plurality of factors is received, with a first factor in the plurality of factors being a moisture content distribution for face veneers and a second factor in the plurality of factors being a moisture content distribution for core veneers. The face veneers are to be placed external to the core veneers in the plywood production. Based on the received data, a first model that models moisture content in produced plywood sheets is developed as a function of at least some of the factors in the plurality of factors. A first effect on a first result of interest is determined based on output from the first model being provided to a second model, with the first and second models being different from one another. A first curve representing a first aspect of the plywood production is created based on output from the second model.

According to certain example embodiments, a second effect on a second result of interest may be determined based on output from the first model being provided to the second model; and a second curve representing a second aspect of the plywood production may be created based on the output from the second model. The first result of interest may be a high moisture content related error and the second result of interest may be a low moisture content related error, e.g., with the first curve being indicative of a first area where high moisture content related errors are to be expected based on a first set of conditions and with the second curve being indicative of a second area where low moisture content related errors are to be expected based on a second set of conditions.

In certain example embodiments, a method for modelling plywood mill performance at a mill is provided. The method may comprise: accessing a model of plywood production generated according to the techniques disclosed herein; gathering data relevant to the manufacture of plywood at the mill, at least some of the data including (a) a face veneer moisture content distribution measured at the mill, and (b) a core sheet moisture content distribution measured at the mill; providing at least the gathered data to the first model to determine an overall moisture content distribution for the mill; and modelling the plywood mill performance at the mill using the overall moisture content distribution and the first curve, wherein the first curve at least partially defines an area where a moisture content related error is to be expected.

In certain example embodiments a method for modelling expected plywood mill performance at a mill is provided. The method may comprise: accessing a model of plywood production generated according to the techniques disclosed herein; receiving data indicative of at least one prospective process parameter change for the manufacture of plywood at the mill; providing at least the received data to the first model to determine an expected overall moisture content distribution for the mill; and modelling the expected plywood mill performance at the mill using the expected overall moisture content distribution and the first curve, wherein the first curve at least partially defines an area where a moisture content related error is to be expected.

In certain example embodiments, there is provided a non-transitory computer readable storage medium tangible storing instructions that, when executed by a processor of a computer, perform the techniques disclosed herein. Similarly, in certain example embodiments, there is provided a system for modelling production of an engineered and/or composite wood product (such as plywood), comprising processing resources including at least one processor and a memory coupled thereto, the processing resources being configured to perform operations corresponding to the techniques disclosed herein.

Although the use of the models may in some instances be seen as in some ways involving mathematical methods, Certain example embodiments also provide specific technical applications and provide specific technical contributions. For instance, the use of the models of certain example embodiments (including, for example, the first and second models, which may be regression and Bayesian-based models in some implementations), e.g., for the purpose of identifying one or more different kinds of moisture related errors in composite and/or engineered wood products, provides a technical contribution.

Further examples of technical contributions include (1) controlling a specific technical system or process (e.g., a process used in producing engineered and/or composite wood products like plywood), e.g., by adjusting press conditions, adhesive spread, dyer time and/or temperature, and/or the like; (2) determining from moisture and/or other measurements separate required parameters (e.g., press conditions, species, dryer parameters, etc.) needed to achieve an overall moisture content of a product being produced so as to avoids low- and/or high-moisture content related errors; (3) estimation of the quality of products produced, e.g., in terms of likelihood of failure, robustness, etc.; (4) determining the energy expenditure of a production process by processing data obtained from moisture sensors taking measurements from veneers and/or final products; etc.

The features, aspects, advantages, and example embodiments described herein may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1A is a graph plotting moisture-related measurements for three different kinds of heartwood strips oftentimes used in plywood;

FIG. 1B is a histogram in which the FIG. 1A species 1 heartwood strip data has been broken down into different dryness categories in accordance with certain example embodiments;

FIG. 1C is a histogram in which the FIG. 1A species 2 heartwood strip data has been broken down into different dryness categories in accordance with certain example embodiments;

FIG. 1D is a histogram in which the FIG. 1A species 3 heartwood strip data has been broken down into different dryness categories in accordance with certain example embodiments;

FIG. 2A includes moisture-related measurements for different kinds of sapwood samples;

FIG. 2B is a histogram in which the FIG. 2A species 1 sapwood strip data has been broken down into different dryness categories in accordance with certain example embodiments;

FIG. 2C is a histogram in which the FIG. 2A species 2 sapwood strip data has been broken down into different dryness categories in accordance with certain example embodiments;

FIG. 2D is a histogram in which the FIG. 2A species 3 sapwood strip data has been broken down into different dryness categories in accordance with certain example embodiments;

FIG. 3A includes moisture-related measurements for species 1 heartwood and sapwood strip samples following debarking and an initial drying, as well as for redried strip samples;

FIG. 3B is a histogram in which the FIG. 3A redried species 1 strip data has been broken down into different dryness categories in accordance with certain example embodiments;

FIG. 4A includes moisture-related measurements for different kinds of heartwood sheet samples;

FIG. 4B is a histogram in which the FIG. 4A species 1 heartwood sheet data has been broken down into different dryness categories in accordance with certain example embodiments;

FIG. 4C is a histogram in which the FIG. 4A species 2 heartwood sheet data has been broken down into different dryness categories in accordance with certain example embodiments;

FIG. 4D is a histogram in which the FIG. 4A species 3 heartwood sheet data has been broken down into different dryness categories in accordance with certain example embodiments;

FIG. 5A includes moisture-related measurements for different kinds of sapwood sheet samples;

FIG. 5B is a histogram in which the FIG. 5A species 1 sapwood sheet data has been broken down into different dryness categories in accordance with certain example embodiments;

FIG. 5C is a histogram in which the FIG. 5A species 2 sapwood sheet data has been broken down into different dryness categories in accordance with certain example embodiments;

FIG. 5D is a histogram in which the FIG. 5A species 3 sapwood sheet data has been broken down into different dryness categories in accordance with certain example embodiments;

FIGS. 6A-6B are histograms for species 1 sheets and strips at 10-18% moisture content and less than 10% moisture content, respectively, which together are used to form a sample three-ply panel;

FIG. 7 is a graph showing the moisture content to be expected at the wood-glue interfaces for 26 lbs. and 32 lbs. spread three-ply example plywood products;

FIG. 8 is a graph showing the moisture content to be expected at the outer wood-glue interfaces for 26 lbs. spread four-ply example plywood products

FIG. 9 shows low and high moisture content related failure curves in connection with the FIG. 8 example;

FIG. 10 is a flowchart showing a process for developing low and/or high moisture content related failure curves, in accordance with certain example embodiments;

FIG. 11 is a flowchart showing a process for using the error curve(s) developed using the FIG. 10 example approach to predict errors in plywood manufacturing, in accordance with certain example embodiments; and

FIG. 12 is a block diagram showing hardware and software components that may be used in connection with certain example embodiments.

### DETAILED DESCRIPTION

Certain example embodiments relate to techniques for predicting, and/or suggesting process parameter changes to address, failures in the manufacturing of wood products such as, for example, plywood.

The techniques of certain example embodiments consider moisture content of the wood used in the engineered and/or composite wood product. Moisture content may be measured using in-line moisture meters in certain example embodiments. For instance, moisture meters may be used to measure moisture of heartwood and sapwood sheets and/or strips, at least partially assembled plywood panels, etc., in-line, during manufacturing. Moisture meters may determine moisture by using conductivity meters running across the article (e.g., veneer or panel) in some instances. Multiple measurements are taken for each component of a wood product or each piece of wood. It will be appreciated that rather than one specific moisture value, there typically will be a moisture distribution, even in a given veneer, e.g., running across or through its dimensions. For example, for a veneer or panel oriented in a first direction (e.g., a generally horizontal or vertical direction), different moisture measurements may be taken at different intervals, and these different measurements may indicate different moisture values, even though it is the same article being measured at different locations. Thus, the individual, peak, average, and/or other values from the moisture meters may be measured and/or calculated, and recorded, in certain example embodiments. Moisture distribution values (e.g., average and standard deviation, all distribution values, etc.) may be considered in certain example embodiments, e.g., as explained in greater detail below.

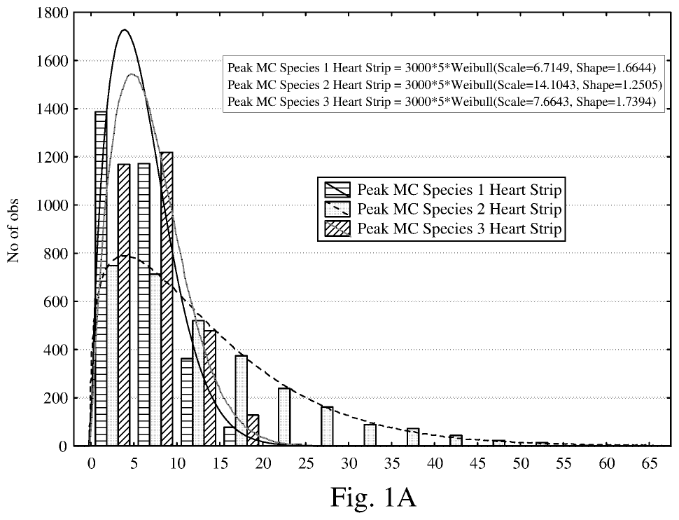

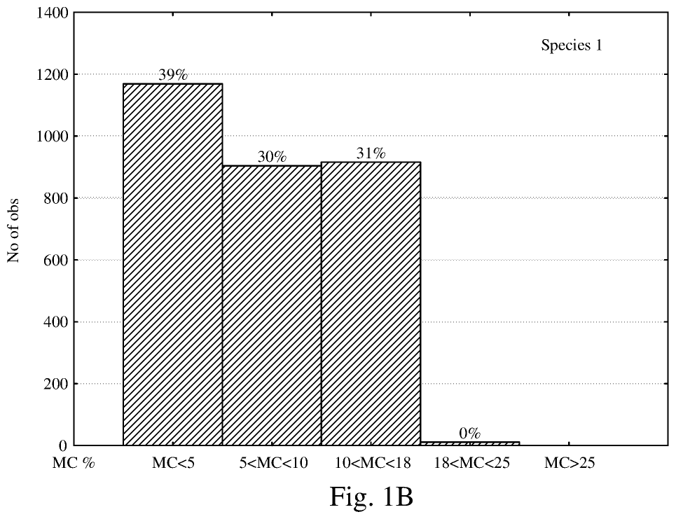

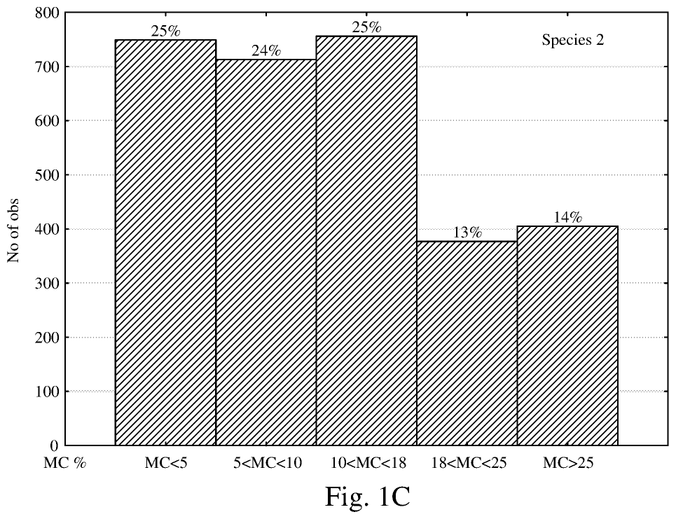

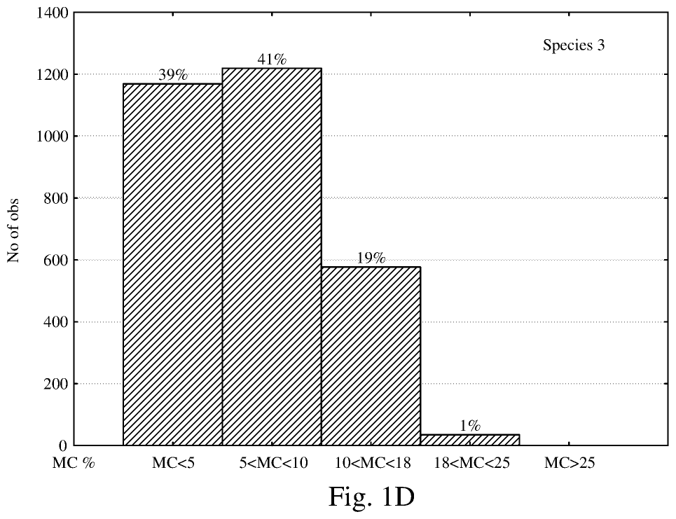

FIGS. 1A-5D show examples of the data that can be gathered and/or computed in certain example embodiments. This gathered and/or computed data is processed to predict failures in, suggest process parameters changes for, and/or simulate effects of changes in the manufacturing of, different wood products, in accordance with certain example embodiments. More particularly, and as will be appreciated from the description below, this or similar data may be gathered at a given mill, and/or experimentally outside of a particular mill's operation. The thus-gathered data may be used to determine conditions where failures are likely to occur (which may be represented by a curve or the like), model the performance of a mill with set process parameters and/or other conditions given this error determination based on this determination, predict what might happen as a result of a potential change to one or more process parameters and/or other conditions, develop a set of improved or optimum process parameters, etc.

FIG. 1A is a graph plotting moisture-related measurements for three different kinds of heartwood strips oftentimes used in plywood. More particularly, FIG. 1A includes moisture-related measurements for heartwood from three different wood species used in plywood, following debarking and an initial drying. Common wood species used in plywood include Douglas Fir (DF), Pine, White Fir (WF), Southern Yellow Pine, Spruce, Birch, Radiata Pine, and others. As is known, heartwood is the inner part of the tree's wood, which tends to be harder than the outer parts. The samples were strips of wood, meaning that they are used as cross-ply veneers internal to a plywood product. Multiple different moisture-related measurements were taken from each of the thousands of different samples of each species. More or fewer measurements can be taken for different, and/or more or fewer, samples in different instances, e.g., depending on the size of the veneer, desired accuracy, whether and how such distribution data will be used, etc. In the case of FIG. 1A, the histogram reflects the peak moisture percentage values for each of the different samples for each of the different species. More specifically, based on the measurements for the samples, Weibull distributions were calculated for each of the species, and the scale and shape of the distributions are shown in FIG. 1A. It will be appreciated that other distributions different from Weibull distributions can be calculated in certain example embodiments, here and/or elsewhere. Weibull distributions have been found to be advantageous, however, because they do not produce values below 0 (which would be a meaningless result in the context of a moisture measurement for a plywood veneer, because as a practical matter there cannot be less than 0% moisture in this type of operation).

In some examples, other factors may be used in addition, or as an alternative, to the moisture values shown in connection with the examples of FIGS. 1A-5D. Other measured values may include, for example, cure rate of the resin, press conditions (including any of press temp, pressure, and/or time), ambient conditions, application rates, adhesive distribution, and wood species. Each or any of these may, as described elsewhere herein, be used in connection with a holistic model that may be employed in certain examples.

In the FIG. 1A example, and consistent with the operation of moisture meters, moisture percentages at the surface were recorded. Based on domain expertise and/or past testing, different categories of wetness were defined for different moisture percentage ranges. The following example for a heartwood strip illustrates six example moisture content (MC) categories in the form of a moisture content profile:

TABLE 1

| | Moisture |
|---|---|
| | Content |
| Level | (MC) |
| Over-dry | <5% |
| Level 1 | 5-10% |
| Level 2 | 10-18% |
| Level 3 | 18-25% |
| Redry | >25% |

Of course other moisture content profiles may be used/defined depending on, for example, the nature of the wood (e.g., the species), the history and/or location of the mill that is doing the processing, and other factors.

With these categories, heartwood strips classified as belonging to the level 1 category may be used in manufacturing without further processing. Oftentimes, strips in the over-dry category will be used as well. Heartwood strips classified as belonging to the level 2-3 categories may be set down for a set-down period (e.g., for 24 hours) to allow them to further equilibrate or dry out. This set-down period enables the strips to “naturally” dry out at least somewhat and equilibrate to a moisture content that is usable following the set-down period. Heartwood strips classified as belonging to the “redry” category may be re-dried using a dryer operating for a preset time and temperature. It will be appreciated that these and/or other ranges can be used in different example embodiments. In general, there will be at least three different categories of wetness, corresponding to samples that are usable immediately without further processing, samples that need to be set down for a period to equilibrate, and samples that need to be redried. In certain example embodiments, rather than having categorical moisture groupings (e.g., as reflected in the table above), numerical moisture values can be used. In certain example embodiments, these thresholds can be adjusted, and the effects of such adjustments can be modelled, e.g., by examining the effect(s) on the error curves discussed in greater detail below. As an initial value, the thresholds may be set to what has been known to work at a given mill in the past.

FIG. 1B is a histogram in which the FIG. 1A species 1 heartwood strip data has been broken down into different dryness categories in accordance with certain example embodiments, FIG. 1C is a histogram in which the FIG. 1A species 2 heartwood strip data has been broken down into different dryness categories in accordance with certain example embodiments, and FIG. 1D is a histogram in which the FIG. 1A species 3 heartwood strip data has been broken down into different dryness categories in accordance with certain example embodiments. As shown in FIGS. 1B and 1D, the majority of the wood may be used in further processing steps immediately and without further intervention because it falls into the over-dry or level 1 category, and smaller percentages (including those samples that fell into level 2 or 3 categories) may be used after a set-down period of 24-hours or the like.

In the case of species 2, the long tail in the Weibull curve proves to be problematic when the species 2 heartwood strips are sorted. More particularly, as shown in FIG. 1C, 38% of the species 2 heartwood strips needs to be set down (level 2 and 3 categories), and 14% must be redried (corresponding to the redry category). The set-down period injects delays into the process. Redrying has its own manufacturing-related problems, as it increases processing time and requires additional energy. Redrying also tends to make to make the wood brittle, which can have negative downstream implications for the plywood (e.g., in terms of bond strength and/or the like).

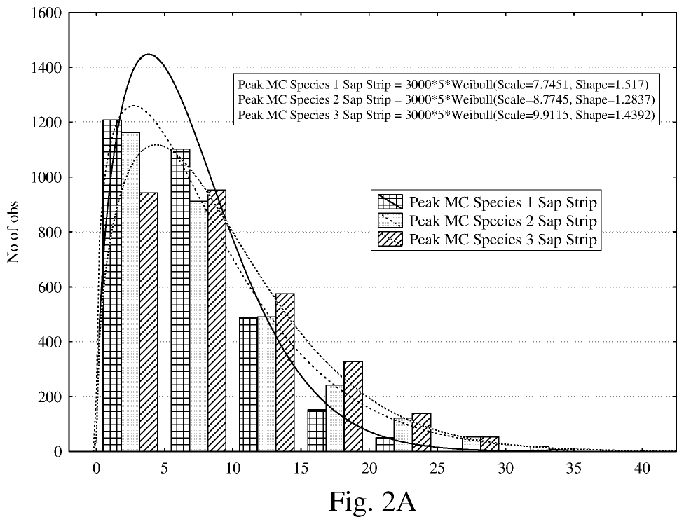

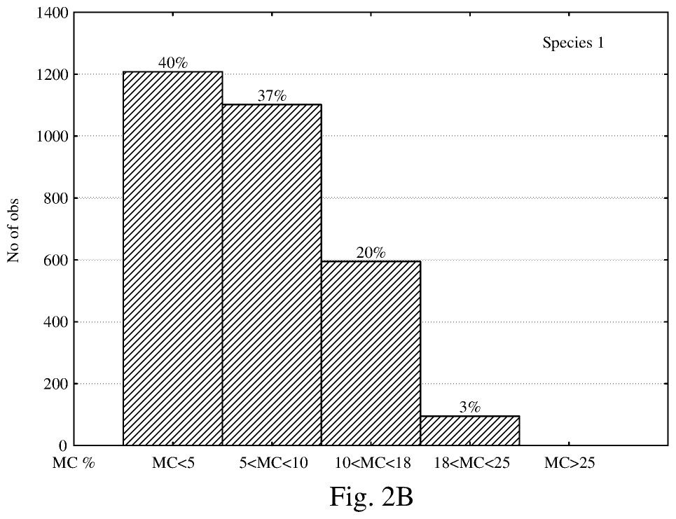

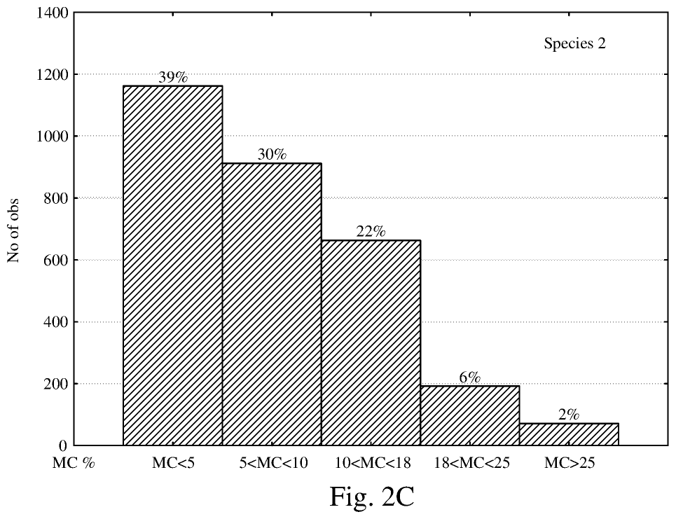

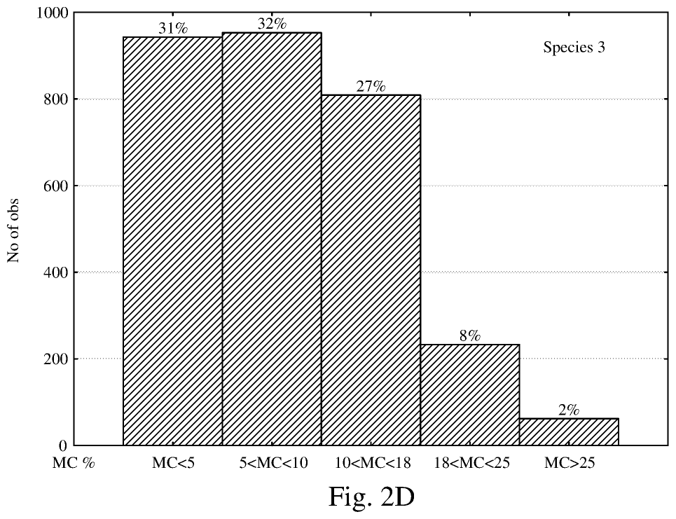

FIGS. 2A-2D are similar to FIGS. 1A-1D, except that FIGS. 2A-2D are provided for sapwood strip samples. Thus, FIG. 2A includes moisture-related measurements for three different species sapwood strip samples, following debarking and an initial drying. As is known, sapwood is the softer part of the tree's wood between the heartwood and the bark. As with FIG. 1A, in FIG. 2A, multiple different moisture-related measurements were taken for each of 3,000 different samples of each species. In FIG. 2A, the histogram plots the peak moisture percentage values for each of the different samples for each of the different species, and Weibull distributions were calculated for each of the species.

In this example, the same categories of wetness as defined and used for the heartwood strips also were defined and used for the sapwood strips. However, it will be appreciated that different categories of wetness or numerical values may be used in different instances. FIG. 2B is a histogram in which the FIG. 2A species 1 sapwood strip data has been broken down into different dryness categories in accordance with certain example embodiments, FIG. 2C is a histogram in which the FIG. 2A species 2 sapwood strip data has been broken down into different dryness categories in accordance with certain example embodiments, and FIG. 2D is a histogram in which the FIG. 2A species 3 sapwood strip data has been broken down into different dryness categories in accordance with certain example embodiments.

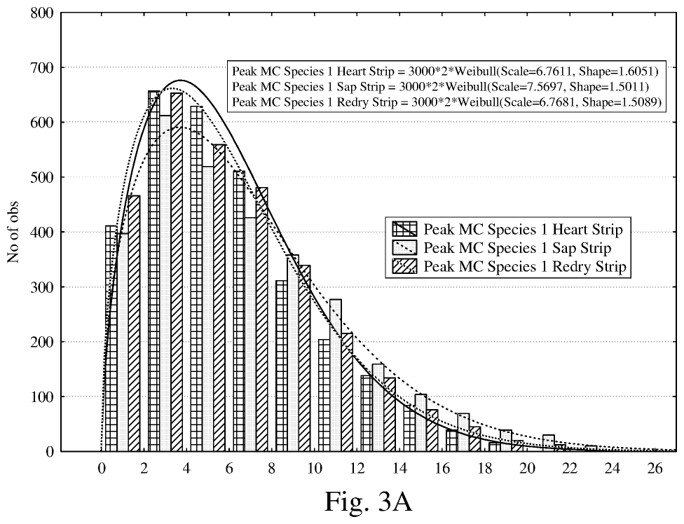

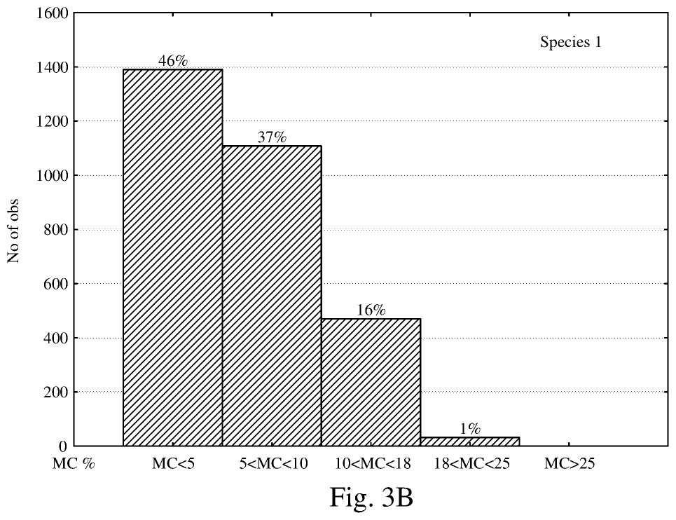

FIG. 3A includes moisture-related measurements for species 1 heartwood and sapwood strip samples following debarking and an initial drying, as well as for redried species 1 strip samples. The moisture-related measurements for the species 1 heartwood and sapwood strip samples in FIG. 3A correspond with the type of data from FIGS. 1A and 2A, respectively (e.g., although certain samples that were too wet and/or too dry may have been removed in the FIG. 3A chart). In this example, the same categories of wetness as defined and used for the heartwood and sapwood strips also were defined and used for the redried strip samples. However, it will be appreciated that different categories of wetness or numerical values may be used in different instances. FIG. 3B is a histogram in which the FIG. 3A redried species 1 strip data has been broken down into different dryness categories in accordance with certain example embodiments.

It will be appreciated that the same or similar data can be generated for the species 2-3 heartwood and sapwood samples discussed above, as well as for any species 2-3 redried strip samples. Although certain example embodiments have been described in connection with heartwood and sapwood, it will be appreciated that the same or similar techniques also can be used for medium wood strip samples. As is known, medium wood is intermediate the heartwood and sapwood. The same or different moisture thresholds may be used for one or more of these different species of wood and/or the different areas of wood from which the strips were generated (i.e., the heartwood, medium wood, and sapwood), in different example embodiments. “Full” wood sheets typically are used as the front ply and the back play, whereas wood strips typically are used as interior plies in plywood. It will be appreciated, however, that full-size sheets may be used as cross-grain strips in some instances. It also will be appreciated that the techniques disclosed herein may be used in connection with different sized strips (e.g., strips that are 27″ wide, 54″ wide, or otherwise sized).

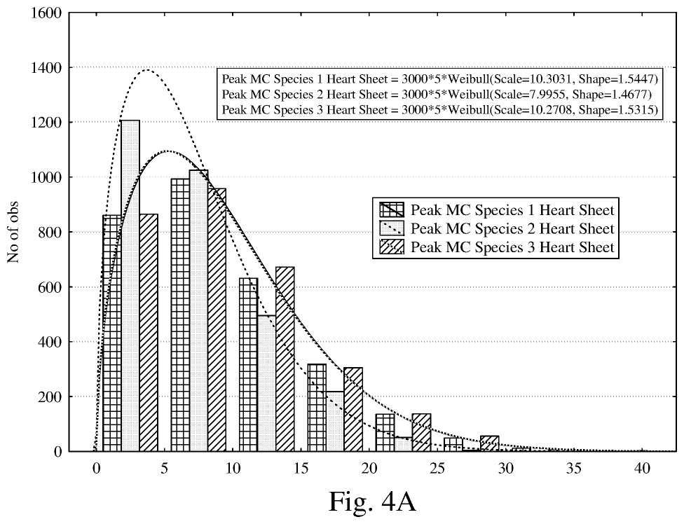

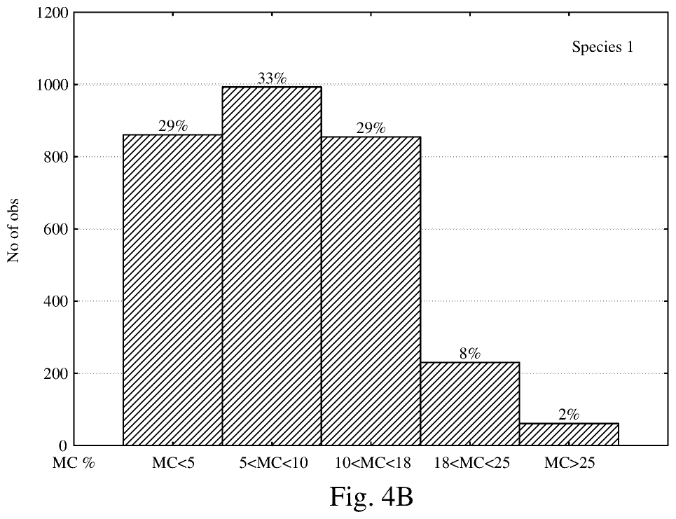

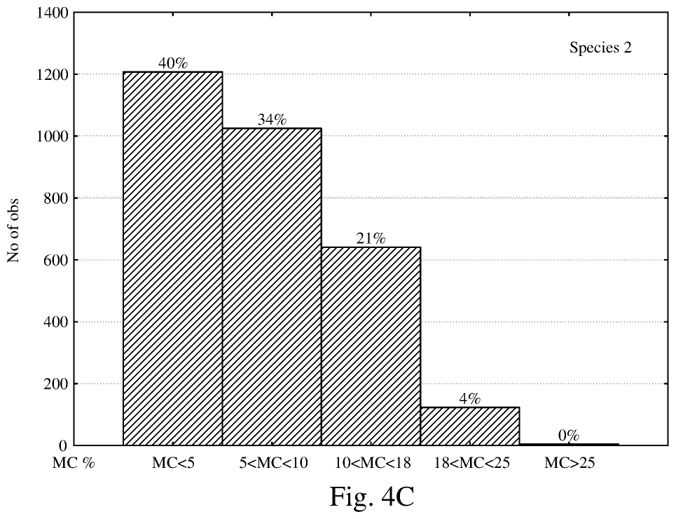

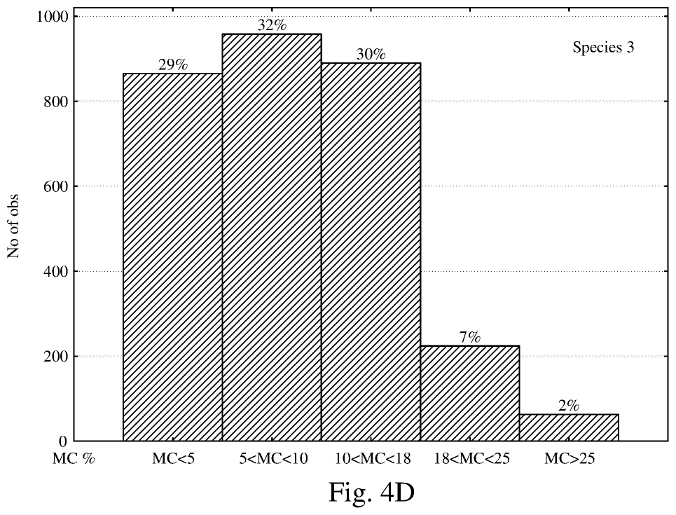

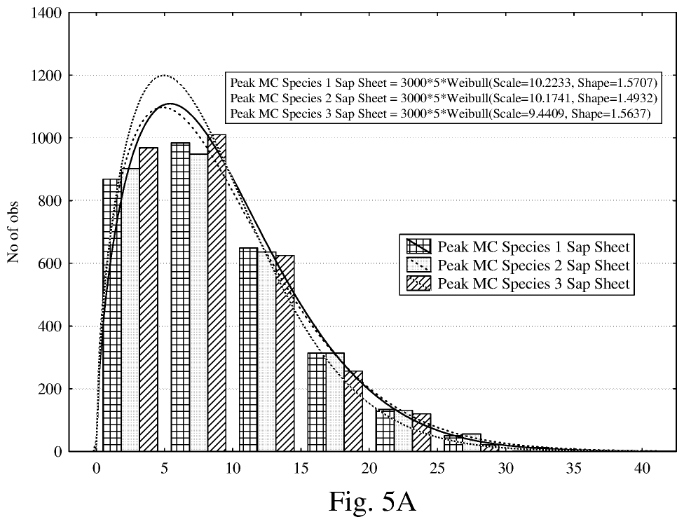

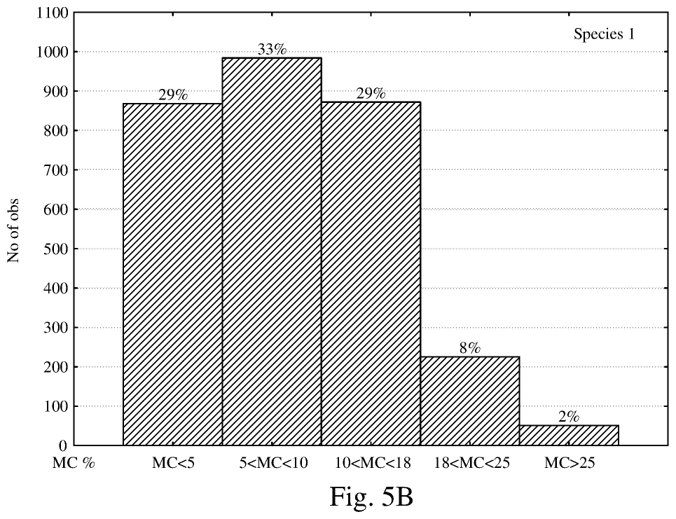

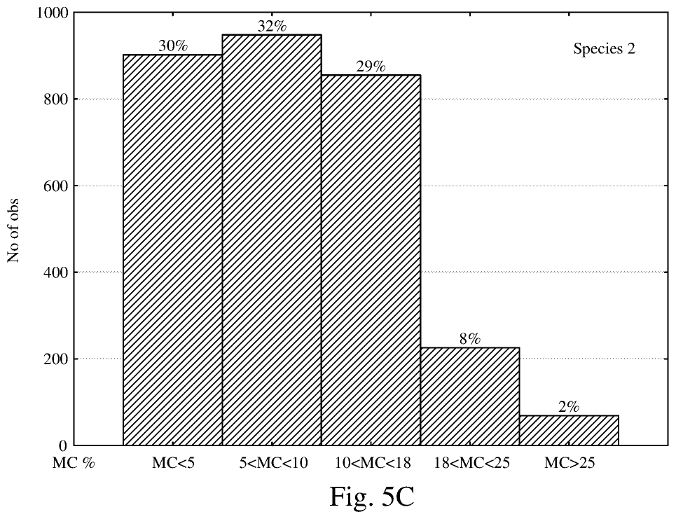

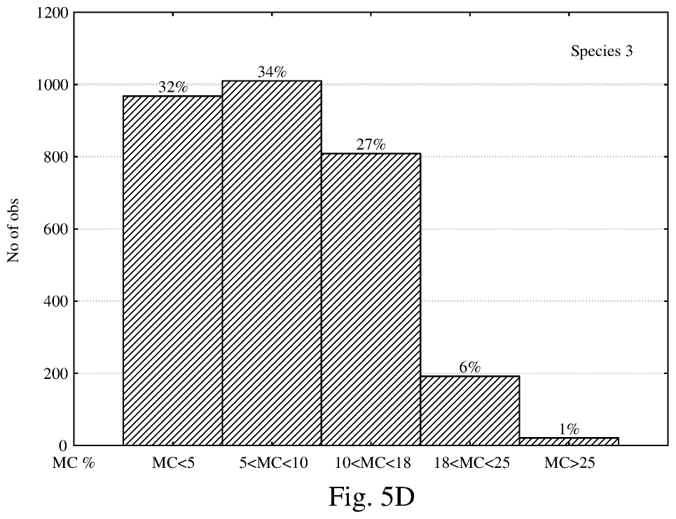

The same or similar data as discussed above can be gathered for wood sheets in addition to wood strips. In this regard, FIGS. 4A-5D are similar to FIGS. 1A-2D, with FIG. 4A including moisture-related measurements for three different kinds of heartwood sheet samples. As with FIG. 1A, in FIG. 4A, multiple moisture-related measurements were taken from each of thousands of different samples of each species. In FIG. 4A, the histogram plots the peak moisture percentage values for each of the different samples for each of the different species, and Weibull distributions were calculated for each of the species.

In this example, the same categories of wetness were defined for the same moisture percentage ranges for the heartwood sheets, as compared to Table 1.

Of course, in different examples, different categories may be defined for the same or different percentage ranges. For instance, although not described here, in some instances, it may be desirable to provide six example moisture content (MC) categories in the form of a moisture content profile. Other moisture content profiles may be used/defined depending on, for example, the nature of the wood (e.g., the species), the history and/or location of the mill that is doing the processing, and other factors. In an example where there are six different categories, for instance, over-dry sheets may not be used at all, level 1-2 sheets may be used immediately, level 3-4 sheets may be used after a set-down period, and some sheets may be used after being redried.

In general, as above, different categories include thresholds for wood sheets that are usable immediately, wood sheets that are usable after a set-down period, and wood sheets that need to be redried. In some instances, a greater tolerance for moisture may be permitted on the sheets because they likely will be used as external plies and thus will have an opportunity to dry out “on their own” in subsequent manufacturing, handling, shipping, etc., compared to strips which may be seen to trap moisture in the plywood, which could interfere with the bond formed by the glue. However, the inventors have recognized that despite this idea, at least some mills use different thresholds, e.g., less moisture being permitted on the external sheets compared to the strips. It is believed that this is an artifact of simply adopting “what works,” and could be an area for improvement based on modelling. Thus, it may be desirable to define thresholds different from what is conventional, e.g., in terms of permitting more moisture on the sheets compared to strips in some instances.

FIG. 4B is a histogram in which the FIG. 4A species 1 heartwood sheet data has been broken down into different dryness categories in accordance with certain example embodiments, FIG. 4C is a histogram in which the FIG. 4A species 2 heartwood sheet data has been broken down into different dryness categories in accordance with certain example embodiments, and FIG. 4D is a histogram in which the FIG. 4A species 3 heartwood sheet data has been broken down into different dryness categories in accordance with certain example embodiments.

FIGS. 5A-5D are similar to FIGS. 4A-4D, except that FIGS. 5A-5D are provided for sapwood sheet samples rather than heartwood samples as in FIGS. 4A-4D. Thus, FIG. 5A includes moisture-related measurements for different kinds of sapwood sheet samples. As with FIG. 4A, in FIG. 5A, multiple moisture-related measurements were taken from each of thousands of different samples of each species. In FIG. 5A, the histogram plots the peak moisture values for each of the different sapwood samples for each of the different species, and Weibull distributions were calculated for each of the species.

In this example, the same categories of wetness as defined and used for the heartwood sheets also were defined and used for the sapwood sheets. However, it will be appreciated that different categories of wetness or numerical values may be used in different instances. FIG. 5B is a histogram in which the FIG. 5A species 1 sapwood sheet data has been broken down into different dryness categories in accordance with certain example embodiments, FIG. 5C is a histogram in which the FIG. 5A species 2 sapwood sheet data has been broken down into different dryness categories in accordance with certain example embodiments, and FIG. 5D is a histogram in which the FIG. 5A species 3 sapwood sheet data has been broken down into different dryness categories in accordance with certain example embodiments.

As above, the same or similar data can be collected for medium wood sheet samples. Furthermore, as above, the same or similar thresholds can be defined for medium wood sheet samples.

In sum, the same or similar moisture-related data can be collected for multiple different kinds of species for multiple different areas of the wood (heartwood, medium wood, and sapwood) and for multiple different types of veneers (sheets vs. strips). Data can also be collected for samples that are redried and/or set down for equilibration. The moisture-related data can be recorded, and histograms can be generated based on different moisture thresholds. The moisture thresholds can be the same or different for the different kinds of species and/or for the different areas of the wood and/or for the different types of veneers. For instance, different thresholds may be defined for sheets and strips but may be the same for different wood species and different areas of the wood. As another example, different thresholds may vary by species and area of the wood but without regard to veneer type. Other combinations are envisioned herein.

With this data collected from actual mill operations and/or experimentally (e.g., in lab conditions), or with a corpus of other relevant data provided (e.g., based on data aggregated from multiple mills, multiple lab experiments, etc.), the techniques of certain example embodiments can be applied to generating a model of existing manufacturing approaches and/or the effect of a change to one or more manufacturing process parameters.

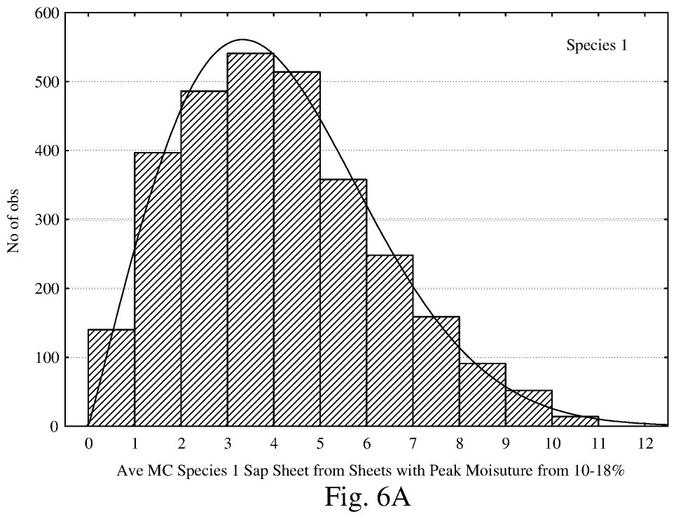

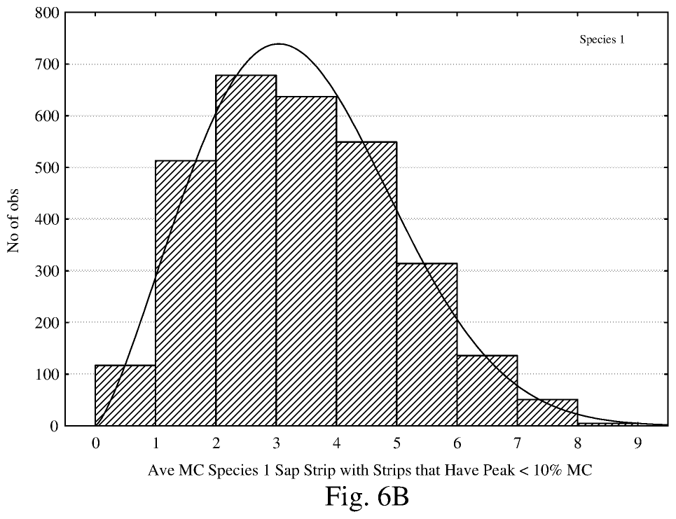

For the purposes of explanation, assume that a three-ply panel is constructed using species 1 sapwood for the front and back sheets at an average of 10-18% moisture content and using species 1 sapwood at an average of less than 10% moisture content for the inner ply. As an example, the spreads are set at either 26 lbs. or 32 lbs. As is known to those skilled in the art, the spread refers to the weight of the glue provided to a 1 ft.×1000 ft. product. FIG. 6A is a histogram for species 1 sapwood sheets with about 10-18% moisture content, and FIG. 6B is a histogram for species 1 sapwood strips a moisture content of less than 10%, which together are used to form a sample three-ply panel. As above, average, peak, or other moisture values may be used in different example embodiments. Weibull or other distributions are calculated for the data therein, and the distribution curves are shown in the FIG. 6A-6B. In some examples, a target reject percentage of 1.2% of products for 26 lbs. spreads can be adopted, while 1.7% of products for 32 lbs. spreads can be used. Veneers that are more moist may be placed on the outside of the panel, and veneers less moist may be placed on the inside of the panel, e.g., to help ensure that less moisture is trapped inside the panel.

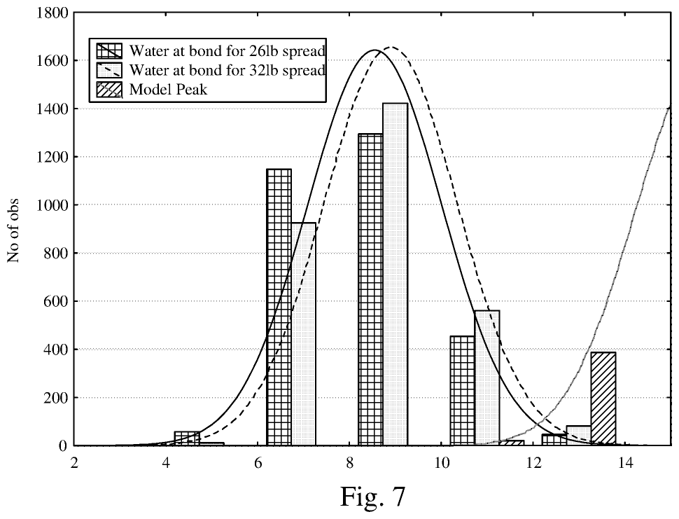

The data for FIGS. 6A-6B may be extracted from the data captured, e.g., as described above in connection with FIGS. 1A-5D. Based on the data shown in FIGS. 6A-6B, a graph as shown in FIG. 7 may be generated. More particularly, the FIG. 7 graph shows the moisture content to be expected at the wood-glue interfaces for 26 lbs. and 32 lbs. spread three-ply example plywood products. The curve to the far right (labelled “model peak”) in essence reflects the probability of a high moisture content related failure, e.g., by modelling the number of expected failures for different moisture content values. The curve may have its own distribution that can be determined experimentally, potentially at the individual mill level, e.g., using the techniques described herein. As shown in the graph of FIG. 7, staying to the left of the high moisture content related failure curve can assist in avoiding failures associated with generated wood products.

In some example embodiments, such techniques may be used to determine where the high moisture content related failure curve accounts for a predetermined error percentage and to determine how much water at the bonds is present at such positions within the curve. With such an approach, the moisture content for the wood (e.g., the sheets and/or strip) can be selected so as to meet the target. In connection with approach, in certain examples, the area under the intersection of the high moisture content related failure curve and the two expected moisture content curves should account for no more than the target error percentages (e.g., approximately 1% in some examples). In some examples, the process parameters used in connection with the generation of the wood products can be changed to thereby modify the two expected moisture content curves—which then alters the area under the intersection of the high moisture content related failure curve and the two expected moisture content curves. The techniques of certain example embodiments thus provide (a) a representation of the high moisture content related failure curve, (b) a process for calculating expected moisture content curves, and/or (c) a process for modelling how different process parameters will affect the expected moisture content curves.

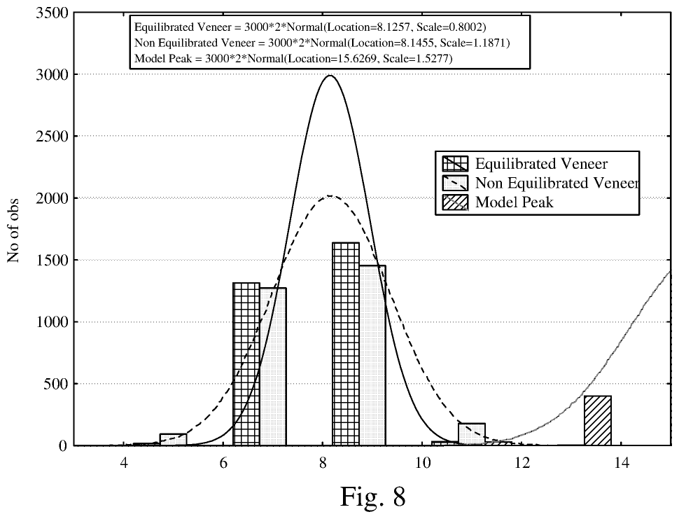

Similar techniques can be used in connection with a four-ply sample product, where species 1 wood is used for the front and back sheets at an average of 0-18% moisture content (in some cases 2-18% moisture content or 10-18% moisture content) and species 1 sapwood at an average of less than 10% moisture content is used for the inner plies. FIG. 8 is a graph showing the moisture content to be expected at the outer wood-glue interfaces for 26 lbs. spread four-ply example plywood products. As above, the curve to the far right of the graph models the number of expected high moisture content related failures. This sample assumes that either equilibrated or non-equilibrated veneers are used. In this example, the non-equilibrated veneers are those that should have been equilibrated based on their moisture content but were not. In this example, the reject percentage for equilibrated veneers is set at 0.089%, and the reject percentage for non-equilibrated veneers is set at 0.4%. Here, the equilibrated veneers have been subject to a 24-hour set down. It can be seen that using equilibrated veneers lowers the variation in the distribution and shifts the distribution to the left. By “squeezing together” the distribution and shifting it (e.g., shifting the peak of the curve) to the left, high moisture content related failures are nearly completely avoided. Thus, FIG. 8 shows the value of equilibrating the veneers. Indeed, as will be appreciated from the discussion below, using non-equilibrated veneers has a negative impact from the standpoint of failures being generated from both moisture content that is too high and moisture content that is too low. In other words, using non-equilibrated veneers negatively impacts both ends of the distribution.

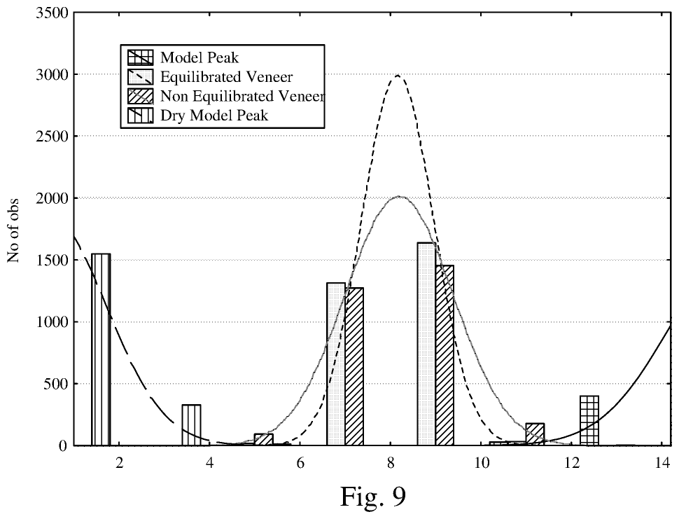

Just as FIGS. 7-8 are concerned with high moisture content related failures, low moisture content related failures also may be of concern. Thus, a curve can be created to model when these issues might occur. In this regard, FIG. 9 assumes the same construction as in FIG. 8, except both low and high moisture content related failure curves are shown, with the “model peak” being a high moisture content related failure and the “dry model peak” being a low moisture content related failure. Low moisture content related failures may be associated with the product being so dry that the glue material will not flow and/or undesirable delamination will occur. High moisture content related failures may be associated with the product being so wet that it “blows,” i.e., there is so much moisture, that a void forms in the panel and the veneers at least partially separate.

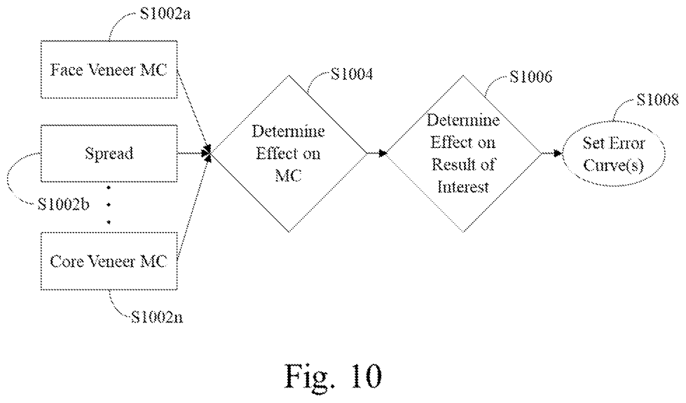

FIG. 10 is a flowchart showing a process for developing failure curves, in accordance with certain example embodiments. As will be appreciated from the discussion below, although the FIG. 10 flowchart is described as being used to develop the low and/or high moisture content related discussed above, curves for other types of errors may be developed using these techniques.

The process of generating or developing a failure curve begins with defining a plurality of factors that are expected to influence and/or do influence the error curve(s) being generated. Additional factors beyond those discussed in connection with FIG. 10 are discussed below. In some examples, different types of veneers may be used to generate different curves—e.g., as the different strengths/physical properties of the veneer are used in connection with the creation of the wood product.

With these factors defined, data is retrieved regarding the actual moisture content produced in the panels based on variations of these factors. This data may be retrieved from experiments performed in a lab, based on actual mill data (received in real time and/or from historical reports), from a corpus of predefined outputs, etc.

In FIG. 10 data is retrieved on factors including the face veneer moisture content (step S1002a), spread (step S1002b), and core veneer moisture content (step S1002n), etc. In other words, in certain example embodiments, experiments may be performed with different moisture contents for the face and core veneers, spreads, etc., to catalog the effects that different values have on the moisture content of the panels produced.

Next, at S1004, the effects on the panels produced are determined from these tests. For example, a model may be used to determine the effect on the moisture content of the panels. The model may be a linear or other regression model, with or without interaction terms, in certain example embodiments. In the case of a regression model, for example, these and/or other factors may be inserted into a linear regression equation, which may assign coefficients to each factor and/or coefficients to interaction variables, e.g., depending on whether they have a statistically significant impact on the regression (e.g., a p-value below a certain threshold, such as p<0.05 in certain example embodiments, p<0.01 in certain other example embodiments, etc.). Other models besides regressions models may be used in certain example embodiments. For example, neural networks may be used in certain example embodiments in place of, or in addition to, a regression model.

At S1006, the outputs from the model at S1004 are inserted into a second model to determine an effect on a result of interest. For example, the coefficients in the linear regression model may be used as centroids of a Bayesian distribution in connection with a Naïve Bayesian Network type model. The effect on a result of interest is determined in this step of the process. In this case, the result of interest may be the expected errors or reject products caused by a moisture content in the end panel that is either too low or too high. Naïve Bayesian analysis may be performed to help determine the effect of the moisture content, spread, etc., on the particular failure modes of interest. For example, the result of interest may be a failure of the overall panel, the need to redry a veneer, the time and/or temperature used in a hot press, the pressure and/or time used in a cold or hot press, etc.

In S1008, in the case where high and low moisture content related failures are concerned, the analysis provides the error curve(s) (e.g., as introduced into FIGS. 7-9).

In essence, the Naïve Bayesian Network type model in this case provides the probability of a failure given output from the regression model. For those failure results that are found to be statistically significant over a threshold value (e.g., p<0.05, p<0.01, or any other suitable probability value), a failure is logged. The aggregation or sum of those logged statistically significant failures produces the curves shown in FIGS. 7-9. It will be appreciated that the curves shown in FIGS. 7-9 can be two-dimensional, as implied from a simple Bayesian calculation where there is a determination of P (Failure|Regression Output), or the probability of a failure given a regression output. However, it will be appreciated that a multidimensional output from the Bayesian calculation can be provided, leading to a multidimensional failure area. For instance, where there is a two-dimensional output from the regression model in step S1004, the determination in step S1006 will look more like P (Failure|Regression Output₁ AND Regression Output₂), implying a two-dimensional “curve” (and thus a three-dimensional area “under” that curve) being produced in step S1008. In connection with the curve being set in step S1008, it will be appreciated that a curve or the like may be determined based on discrete data points. For instance, a Gaussian or other distribution, power curve, exponential curve, or the like may be calculated from the output of step S1006. In such cases, the curve may be truncated based on the factors of interest. For instance, where there is a desire to determine P (Moisture Content Related Failure|Moisture Content Regression Output), the curve may be truncated because moisture contents above or below a particular value will be known to cause a problem, or because certain values might be meaningless based on the context (e.g., a moisture content value that is known to be meaningless, a hot press temperature less than a threshold such as ambient temperature may be deemed meaningless, etc.). This threshold for truncating the curves may be known based on domain expertise, it may be linked to the thresholds defined above, and/or it simply may be set at a given percentage (e.g., whether 100%, 0%, or above and below those values depending on the particular application for which the percentages are being used), since there cannot be moisture contents that exceed those values. As mentioned, although certain example embodiments refer to curves, it will be appreciated that those curves may take different shapes and/or define different areas. Thus, the term “curve” should not be understood to be a continuous two-dimensional line with at least one arcuate portion unless specifically claimed. Generally straight, rectilinear, and/or other shapes may still be considered curves, as may the areas implied by such shapes.

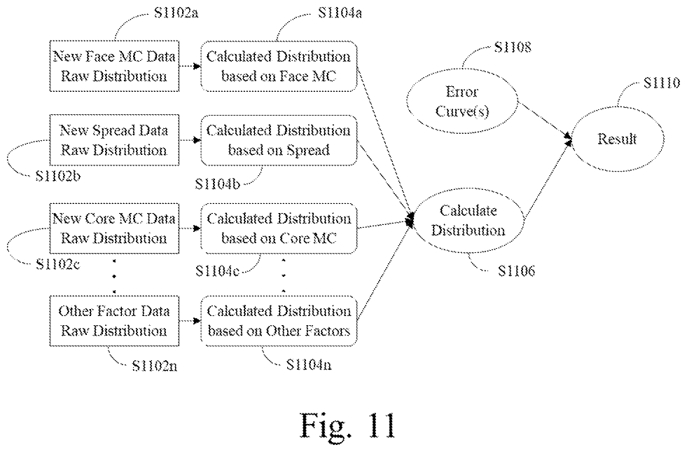

FIG. 11 is a flowchart showing a process for using the error curve(s) developed using the FIG. 10 example approach to predict errors in plywood manufacturing, in accordance with certain example embodiments.

Raw data distributions from a variety of sources are received. For instance, raw data distributions for face sheet moisture content (step S1102a), spread (step S1102b), core strip moisture content (step S1102c), and other factors (step S1102n) are measured and received.

In order to increase the information available, a simulation approach is used on each of the raw data distributions. For example, a Markov Chain Monte Carlo (MCMC) simulation may be performed on the raw data distributions (in steps S1104a-S1104n) with a random distribution based on the raw data. A Metropolis-Hastings or other algorithmic approach can be used in this regard.

A point-to-point calculation is performed on the factors with the linear regression calculated in FIG. 10 to determine the distribution of the calculated moisture content distribution (step S1106). In other words, the measured and/or sampled distribution data is fed into the first model calculated in FIG. 10.

The error curve(s) information is retrieved (step S1108). The overlap of the error curve(s) and the calculated distribution is calculated to determine the result (step S1110). If the error curve is for a high moisture content related error, then the overlap result will yield a maximum moisture content for the given distribution. If the error curve is for a low moisture content related error, then the overlap result will yield a minimum moisture content for the given distribution. If both error curves are provided, then a range of acceptable values will be indicated. Further, if both error curves are provided, then the manufacturing process can be tuned to decide whether to “favor” constructions that are towards the too dry side or too wet side of the distribution. This may be valuable in situations where the distribution is quite skewed (e.g., because the mill is in a very dry or very humid area).

Example factors that may be used in connection with the processes shown in FIG. 10 and/or FIG. 11 include: (1) veneer moisture variation, (2) a binary indication of whether the veneer has been moisture equilibrated, (3) veneer temperature (e.g., peak and/or average), (4) veneer temperature variation, (5) veneer species variation (e.g., an indication of whether different species are used for different plies, an indication of what types of species are used, etc.), (6) an indication of where in a plywood product different types of species are used, and/or the like, (7) inhomogeneity of the veneer, (8) veneer thickness, (9) spread amounts, (10) spread variation, (11) glue type, (12) glue cure speed, (13) mill ambient conditions (e.g., temperature, relative humidity, etc., with potential regional and/or seasonal adjustments), (14) adhesive type, (15) adhesive cure speed, (16) press parameter variations (e.g., pressure used, temperature, time, etc.), (17) the temperature of the glue, (18) face veneer moisture content, (19) core veneer moisture content, etc. Multidimensional factors (e.g., taking into account these and/or other factors) may be used, as well.

The results of tests can be fed into the models generated in FIGS. 10-11 in certain example embodiments and/or the outcomes of tests can be predicted using the techniques described in FIGS. 10-11. For plywood, LVL, and other composite or engineered wood products, tests of interest include internal bond, short span shear, bending, wood failure (e.g., where a sample's aging is accelerated and then pulled apart to determine how much the wood breaks compared to how much the glue breaks, with the former being preferred to the latter), and lap shear tests. Other tests of interest include screw pull, emission (e.g., amount of formaldehyde or other material), face pull, water soak/thickness swell, linear expansion (e.g., which is a problem especially troublesome for flooring materials), creep (e.g., similar to the sag or saddle of a shelf when there are too many books placed upon it), and/or other tests. It is noted that in exterior grade plywood or ps-1 rated plywood, the wood failure rate may have to be below a set value based on the usage. Different rates may be different for differently graded plywood and/or different products. Other test can be specified, e.g., depending on the product. For instance, LVL typically has a bending requirement that may be of interest in some instances.

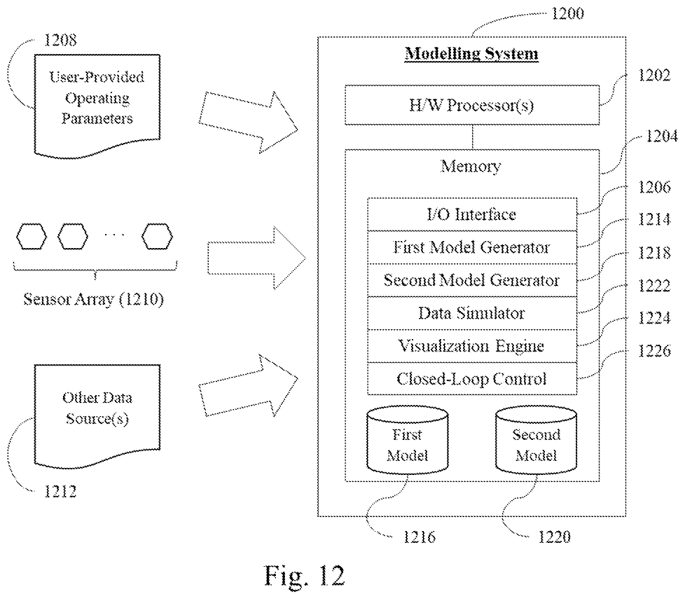

FIG. 12 is a block diagram showing hardware and software components that may be used in connection with certain example embodiments. FIG. 12 shows a modelling system 1200 that is computer based. In this regard, the modelling system 1200 includes at least one hardware processor 1202, which is operatively coupled to a memory 1204. The memory 1204 stores instructions that, when executed by the at least one processor 1202, is configured to perform the methods/processes/operations/etc. described herein (e.g., including with regard to FIGS. 10-11). The memory 1202 thus includes software modules such as those shown in and described in connection with FIG. 12. It will be appreciated that these modules may be implemented on the same or different machines in these and/or other appropriate configurations. Thus, the modules present notional distinctions between components, but these distinctions should not be interpreted to mean that different functionalities are provided in different modules, unless specifically claimed. The modelling system 1200 itself may be implemented on a standalone computer, in a cloud-based or other distributed computing environment (e.g., where a user accesses functionality of the modelling system 1200 via a web-based or other portal), or the like. A software portion of an input/output interface 1206 interfaces with a network connection via application programming interfaces (APIs), web services, physical connections, and/or the like, so that it can receive input from a user and/or a mill. For instance, the input/output interface 1206 can receive user-provided operating parameters 1208 reflecting how the mill operates (e.g., mill hot and/or cold press conditions, species of wood used, type of adhesive used, etc.), data from a sensor array 1210 (e.g., which may include moisture sensors), and/or information from one or more other data sources 1212 (e.g., relating to environmental conditions such as weather at the mill, time/date/season information, etc.).

Differently stated, the modelling system 1200 receives data for a plurality of factors via these and/or other sources. A first factor is a moisture content distribution for face veneers, and a second factor is a moisture content distribution for core veneers. This information may be retrieved via the sensor arrays 1210 and may include raw moisture percentage information. The modelling system 1200 itself may process the received moisture-related information to determine peak, average and/or other attributes of thereof. A third factor might relate to the adhesive used, e.g., the type of adhesive, the adhesive spread, etc. The modelling system 1200 can model plywood production using some or all of this and/or other received data. The received data may be obtained from a mill where the plywood production is to occur, and/or it may be obtained experimentally independent of operation of the mill (e.g., in a lab).

Based on the received data, using the first model generator 1214, a first model 1216 is developed to model moisture content in produced plywood sheets as a function of at least some of the factors/data received via the I/O interface 1206. The first model 1216 may be a regression or other type of model (e.g., a neural network or the like). If the first model 1216 is a regression model, for example, it may include at least one interaction term that represents an interaction between two or more of the factors in the plurality of factors.

The user may specify one or more results of interest. For example, a result of interest might broadly be deemed a moisture content related failure. As a more particular example, first and second results of interest might be specified as high and low moisture content related failures. Other examples include the amount of heat used in a hot press and/or the number of veneers that need to be redried, etc.

A second model generator 1218 is employed to develop a second model 1220. This second model 1220 may be a living model such as, for example, a Naïve Bayesian Network (NBN) or other model. Thus, it is possible to determine an effect on a result of interest based on output from the first model 1216 being provided to a second model 1220. The output from the second model 1220 may indicate a probability of the result of interest occurring, “given” the output from the first model 1226. In other words, output form the first model 1226 is taken as an input to the second model 1220 in certain example embodiments. The first and second models 1216, 1220 are different from one another in the sense that they take different inputs and produce different outputs. However, the first and second models 1216, 1220 may be the same or different kinds of models in different example embodiments.

The second model generator 1218 also helps to create curves representing aspects of the plywood production, e.g., based on output from the second model 1220. For instance, in the case of FIG. 9, the curves represent moisture contents for high and low moisture content related failures.

The curves may be created by aggregating inputs to the second model 1220 that produce outputs indicating that the moisture content related errors will occur, e.g., with a probability above a predefined threshold. The aggregated inputs may be individual data points or the like, and curves may be fit to those data points in certain example embodiments. Data points may be excluded, and/or there may be truncation of the aggregation and/or the curve itself, e.g., based on known attributes of the moisture content related errors (e.g., moisture contents above and/or below certain thresholds may be expected to produce problems, moisture contents above 100% or below 0% are invalid, etc.). In some instances, the curve(s) may at least partially define multi-dimensional space(s).

The visualization engine 1224 may be used to generate output such as that shown and described in connection with FIGS. 1A-9. The models 1216, 1220 may be mill specific, or they may be generic to multiple mills. In certain example embodiments, the models 1216, 1220 may be based on data known to be valid at a plurality of different locations generally, and information specific to a particular mill may be “overlaid” on these “basic” models. In this sense, more broadly applicable models can be generated, distributed, and used, e.g., once modified based on mill-specific information (such as, for example, mill-specific operating parameters, environmental factors, and/or the like).

Once the first model 1216 and the second model 1220 are constructed (and optionally refined based on mill-specific information), plywood mill performance at the mill may be modelled. Data relevant to the manufacture of plywood at the mill may be gathered, e.g., using the same input sources as described above, e.g., so as to access the user-provided operating parameters 1208, information from sensor array(s) 1210, and/or information from other data sources 1212. At least some of the data includes (a) a face veneer moisture content distribution measured at the mill, and (b) a core sheet moisture content distribution measured at the mill. Depending on the amount of data gathered during mill operation, a simulation may be run by the data simulator 1222 on at least some the gathered data to generate one or more expanded distributions. The one more expanded distributions may be provided from the data simulator 1222 to the first model 1216 to determine the overall moisture content distribution for the mill. As indicated above, the data simulator 1222 may execute an MCMC or other algorithm to generate additional data in accordance with the distribution. At least this gathered data is provided to the first model to determine an overall moisture content distribution for the mill. The plywood mill performance at the mill is modelled using the overall moisture content distribution and the curve(s). In this case, the curve(s) at least partially define(s) area(s) where a moisture content related error is to be expected.

As above, the visualization engine 1224 may provide a visualization of the modelled plywood mill performance, e.g., with the visualization including a representation of the overall moisture content distribution for the mill and a representation of the curve(s) such as, for example, in accordance with the visualization shown in FIG. 9.

The visualization engine 1224 may help determine and explain an amount of overlap between a representation of the overall moisture content distribution for the mill and a representation of the curve(s), so that the area(s) where failures are likely to occur can be more easily understood. When the amount of overlap is determined to be above a predetermined threshold (e.g., which may be specified in the user-provided operating parameters 1208), an alert message or the like can be generated to indicate that an expected error rate is high. The message may be displayed on an output device coupled to the modelling system 1200 (e.g., a PC display screen), a message may be delivered to and displayed on a portable device (e.g., a text, email, or push notification may be sent to authorized parties as specified in the user-provided operating parameters 1208), etc. In a similar vein, via a closed-loop control module 1226, one or more parameters affecting the functioning of the mill may be altered in an attempt to reduce the amount of overlap to below the predetermined threshold and thus to reduce the error level. This may be accomplished by automatically sending a computer-mediated message to a system that controls the amount of glue dispersed, changing time and/or temperature of a hot press, altering moisture content levels associated with veneers to be set down and/or redried, etc. The computer-mediated message may be provided via an API, web service call, or other function to accomplish the process change without user intervention in certain example embodiments. In certain example embodiments, the process may be changed automatically if errors (as identified using the techniques herein) are above a certain threshold or match certain predefined “emergency” levels. In certain example embodiments, suggestions for process changes may be generated and sent to an authorized user for review and possible implementation.

In a related regard, what-if scenarios may be generated and run. For example, a method for modelling expected plywood mill performance at a mill may comprise accessing the first and second models 1216, 1220 of plywood production generated according to the above-described techniques. Data indicative of at least one prospective process parameter change for the manufacture of plywood at the mill may be received via the I/O interface 1206. At least that received data may be to the first model 1216 to determine an expected overall moisture content distribution for the mill. The expected plywood mill performance at the mill may be modelled using the expected overall moisture content distribution and the curve(s). An expected effect on throughout may be determined based on an amount of overlap between the expected overall moisture content distribution and the first curve, as explained above. Using this technique may be more efficient, as proposed changes may be simulated using the techniques herein before being deployed to changes how wood products are created at the mill.

In some instances, data indicative of a plurality of different prospective process parameter changes may be received. These prospective process parameters changes may be user specified or they could be specified as a part of an automated optimization mode, e.g., in which user-flagged or automatically-identified parameters are varied in a programmatic manner. In such situations, at least the received data indicative of the plurality of different prospective process parameter changes may be provided to the first model 1216, programmatically, to determine a plurality of different expected overall moisture content distributions for the mill so that expected plywood mill performance is modelled in accordance with a plurality of different scenarios based on these different prospective process parameter changes. The programmatic variation may generate a set of combinations and/or permutations of possible scenarios and model them all, in certain example embodiments. In certain example embodiments, different combinations and/or permutations may be user-specified or computed automatically, e.g., as a part of a computerized optimization mode that generates different combinations and/or permutations. An optimized set of process parameters may be recommended based on the expected plywood mill performance for the different scenarios. Such process parameters may then be deployed to the mill. Using this technique may be more efficient, as a proposed change to the process parameters may be simulated using the techniques herein before being deployed to model changes in how wood products are created at the mill.

In certain example embodiments, a user may provide a first set of process parameters that are fixed and a second set of process parameters that are variable, and the first and second sets of process parameters may be provided to the first model 1216, programmatically, to determine a plurality of different expected overall moisture content distributions for the mill so that expected plywood mill performance is modelled in accordance with a plurality of different scenarios based on the first and second sets of parameters. For example, in some instances, a mill may work only with a certain species (e.g., pine), so that may be locked for optimization purposes. As another example, a mill may have available different glue materials so that may be allowed to vary. In certain example embodiments, a prioritization order for automated optimizations may be specified when specifying the first and/or second sets of process parameters. For instance, it may be desirable to model potential changes to change press temperatures after modelling potential changes to press time, as the latter may be more easily implemented in a real-world scenario. In other words, certain example embodiments may specify the order in which different parameters are to be changed in different optimization routines. As another example, it may be easier to change the spread compared to the moisture content of veneer, so potential changes to the spread should be modelled earlier. In some instances, the second set of process parameters may be variable within defined ranges (which may in some instances be user specified). In some instances, the manner of variation may be specified, e.g., based on operator input, a known set of pre-programmed rules, etc. For example, press times may vary in one minute intervals, species may vary based on what a user indicates is available at a particular mill, etc.

In certain example embodiments, the first result of interest may relate to a hardware component used in the plywood production, e.g., a dryer or an aspect of a dryer such as, for example, moisture content following drying by the dryer.

As mentioned above, certain example embodiments leverage a Bayesian-based approach. Using a Naïve Bayesian Network is well suited to a pass/fail test (e.g., such as predicting whether there is like to be a panel blow or not, whether the plywood passed an internal bond strength requirement or not, etc.), and a continuous factor can be used to the generation of curves. For many or perhaps most industrial applications, a pass/fail test will be of interest, and a Bayesian-based approach can help demonstrate how to approach the fail line but stay above it, and/or provide information on how many failures are to be expected, which may be useful in a broad variety of instances. That said, in certain example embodiments, other approaches may be used in place of, or in addition to, one or both of the first and second models. That is, a Convolutional Neural Network (CNN), Binarized Neural Network (BNN), and/or other model may be used for one or both of these models. For instance, a generalized linear model (GLM) may be used with a CNN, a CNN may be used with a NBN, etc.

Although certain example embodiments have been described in connection with certain wood types, it will be appreciated that these and/or other wood types may be used in different example embodiments. Although certain example embodiments have been described in connection with engineered and composite wood products, it will be appreciated that the techniques described herein may be applicable in other industries. For example, the techniques disclosed herein can be used in connection with error prediction and correction for wood products, laminates (including fiber-reinforced laminates, table-top laminates, etc.), glass mats, and a variety of other areas.

In certain example embodiments, there is provided a method for modelling outcomes related to a modelled attribute of composite and/or engineered wood products being produced. Data is received for a plurality of factors, with at least some of the factors having a numerical distribution of values. Based on the received data, a first model that produces a distribution modelling the attribute of the wood products being produced as a function of at least some of the factors in the plurality of factors is developed. Outcomes related to the modelled attribute are predicted using outputs from the first model and a second model, with the first and second models being different from one another. A first distribution of values is defined for the modelled attribute where the predicted outcomes match a first defined outcome with at least a first threshold probability.

In addition to the features of the previous paragraph, in certain example embodiments, at least some of the received data may be obtained from a mill where the wood products are being or will be produced.

In addition to the features of either of the two previous paragraphs, in certain example embodiments, some of the received data may be obtained experimentally independent of operation of a mill at which the wood products are being or will be produced.

In addition to the features of any of the three previous paragraphs, in certain example embodiments, the first model may be a regression model.

In addition to the features of the previous paragraph, in certain example embodiments, the regression model may include at least one interaction term that represents an interaction between two or more of the factors in the plurality of factors.

In addition to the features of any of the five previous paragraphs, in certain example embodiments, the second model may be a Bayesian based model.

In addition to the features of any of the six previous paragraphs, in certain example embodiments, output from the second model may indicate a probability of the first defined outcome occurring, given the output from the first model.

In addition to the features of the previous paragraph, in certain example embodiments, the first defined outcome may be a moisture content related error.

In addition to the features of any of the eight previous paragraphs, in certain example embodiments, the defined first distribution of values may be represented by a curve, and the defining may comprise aggregating inputs to the second model that produce outputs indicating that the first defined outcome are likely to occur with at least the first threshold probability.

In addition to the features of the previous paragraph, in certain example embodiments, the curve may be fit to the aggregation.

In addition to the features of the previous paragraph, in certain example embodiments, the aggregation and/or the curve may be truncated, e.g., based on known attributes of the first defined outcome.

In addition to the features of any of the 11 previous paragraphs, in certain example embodiments, a second distribution of values may be defined for the modelled attribute where the predicted outcomes match a second defined outcome with at least a second threshold probability, with the first and second defined outcomes indicating unacceptable outcomes that are different from one another, e.g., with the first and second distributions of values defining a space therebetween representing acceptable outcomes.

In addition to the features of the previous paragraph, in certain example embodiments, the first distribution of values may at least partially define a first multi-dimensional space, the second distribution of values may at least partially define a second multi-dimensional space, and a third multi-dimensional space may be defined between the first and second multi-dimensional spaces, e.g., with the third multi-dimensional space being the space representing acceptable outcomes.

In addition to the features of any of the 13 previous paragraphs, in certain example embodiments, data relevant to the manufacture of wood products may be gathered at a mill where the wood products are being produced; at least the gathered data may be provided to the first model to determine an overall moisture content related distribution; and the mill's performance may be modelled using the overall moisture content related distribution and the first distribution of values, e.g., where the first distribution of values at least partially defines an area where a moisture content related error is to be expected.

In addition to the features of the previous paragraph, in certain example embodiments, the gathered data may further include environmental factors relevant to the mill, and mill press conditions.

In addition to the features of either of the two previous paragraphs, in certain example embodiments, a simulation may be run on at least some the gathered data to generate one or more expanded distributions, e.g., where the one or more expanded distributions are provided to the first model.

In addition to the features of any of the three previous paragraphs, in certain example embodiments, a visualization of the mill's performance may be provided, e.g., with the visualization including a representation of the overall moisture content related distribution for the mill and a representation of the first distribution of values.

In addition to the features of any of the four previous paragraphs, in certain example embodiments, an amount of overlap between a representation of the overall moisture content related distribution for the mill and a representation of the first distribution of values may be determined.

In addition to the features of the previous paragraph, in certain example embodiments, when the amount of overlap is determined to be above a predetermined threshold, an alert message indicating that an expected error rate is high may be generated and/or a parameter affecting functioning of the mill may be altered to reduce the amount of overlap to below the predetermined threshold.

In addition to the features of any of the 19 previous paragraphs, in certain example embodiments, data indicative of at least one prospective process parameter change for the manufacture of wood products at a mill where the wood products are being produced may be received; at least the received data may be provided to the first model to determine an expected overall moisture content related distribution for the mill; and the expected mill performance may be modelled using the expected overall moisture content related distribution and the first distribution of values, e.g., with the first distribution of values at least partially defining an area where a moisture content related error is to be expected.

In addition to the features of the previous paragraph, in certain example embodiments, an expected effect on throughput may be determined based on an amount of overlap between the expected overall moisture content related distribution and the first distribution of values.

In addition to the features of either of the two previous paragraphs, in certain example embodiments, data indicative of a plurality of different prospective process parameter changes may be received; and at least the received data indicative of the plurality of different prospective process parameter changes may be provided to the first model programmatically to determine a plurality of different expected overall moisture content related distributions for the mill so that expected mill performance is modelled in accordance with a plurality of different scenarios based on the different prospective process parameter changes.

In addition to the features of the previous paragraph, in certain example embodiments, an optimized set of process parameters may be selected based on the expected mill performance for the different scenarios.

In addition to the features of any of the four previous paragraphs, in certain example embodiments, a first set of process parameters that are fixed and a second set of process parameters that are variable may be received from a user; and the first and second sets of parameters may be provided to the first model, programmatically, to determine a plurality of different expected overall moisture content related distributions for the mill so that expected mill performance is modelled in accordance with a plurality of different scenarios based on the first and second sets of parameters.

In addition to the features of the previous paragraph, in certain example embodiments, the process parameters in the second set of process parameters may be variable within defined ranges.

In addition to the features of any of the 25 previous paragraphs, in certain example embodiments, the first result of interest may relate to a hardware component used in the wood product production.

In addition to the features of any of the 26 previous paragraphs, in certain example embodiments, the modelled attribute may relate to moisture, the composite and/or engineered wood products being produced may be plywood products, and/or the first model may model moisture content in produced plywood products as a function of at least some of the factors in the plurality of factors.

In addition to the features of any of the 27 previous paragraphs, in certain example embodiments, a first factor in the plurality of factors may be a moisture content distribution for face veneers and a second factor in the plurality of factors may be a moisture content distribution for core veneers, where the face veneers are to be placed external to the core veneers in the plywood products being produced.

In certain example embodiments, there is provided a non-transitory computer readable storage medium tangible storing instructions that, when executed by a processor of a computer, perform the method of any of the 28 previous paragraphs. In certain example embodiments, there is provided a system for modelling outcomes related to a modelled attribute of composite and/or engineered wood products being produced, comprising: processing resources including at least one processor and a memory coupled thereto, the processing resources being configured to perform operations corresponding to the method of any of the previous 26 paragraphs.

In certain example embodiments, a method for modelling plywood production is provided. Data for a plurality of factors is received, with a first factor in the plurality of factors being a moisture content distribution for face veneers and a second factor in the plurality of factors being a moisture content distribution for core veneers. The face veneers are to be placed external to the core veneers in the plywood production. Based on the received data, a first model that models moisture content in produced plywood sheets is developed as a function of at least some of the factors in the plurality of factors. A first effect on a first result of interest is determined based on output from the first model being provided to a second model, with the first and second models being different from one another. A first curve representing a first aspect of the plywood production is created based on output from the second model.

In addition to the features of the previous paragraph, in certain example embodiments, a third factor in the plurality of factors may relate to adhesive spread.

In addition to the features of either of the two previous paragraphs, in certain example embodiments, the received data may be obtained from a mill where the plywood production is to occur and/or the received data may be obtained experimentally independent of operation of the mill.

In addition to the features of any of the three previous paragraphs, in certain example embodiments, the first model may be a regression model.

In addition to the features of the previous paragraph, in certain example embodiments, the regression model may include at least one interaction term that represents an interaction between two or more of the factors in the plurality of factors.

In addition to the features of any of the five previous paragraphs, in certain example embodiments, the second model may be a Bayesian based model.

In addition to the features of any of the six previous paragraphs, in certain example embodiments, the output from the second model may indicate a probability of the first result of interest occurring, given the output from the first model.

In addition to the features of the previous paragraph, in certain example embodiments, the first result of interest may be a moisture content related error.

In addition to the features of the previous paragraph, in certain example embodiments, the creating of the first curve may comprise aggregating inputs to the second model that produce outputs indicating that the moisture content related error will occur with a probability above a predefined threshold.

In addition to the features of the previous paragraph, in certain example embodiments, the first curve may be fit to the aggregation.

In addition to the features of the previous paragraph, in certain example embodiments, the aggregation and/or the first curve may be truncated, e.g., based on known attributes of the moisture content related error.

In addition to the features of any of the 11 previous paragraphs, in certain example embodiments, a second effect on a second result of interest may be determined based on output from the first model being provided to the second model; and a second curve representing a second aspect of the plywood production may be created based on the output from the second model. The first result of interest may be a high moisture content related error and the second result of interest may be a low moisture content related error, e.g., with the first curve being indicative of a first area where high moisture content related errors are to be expected based on a first set of conditions and with the second curve being indicative of a second area where low moisture content related errors are to be expected based on a second set of conditions.

In addition to the features of any of the 12 previous paragraphs, in certain example embodiments, the first curve may at least partially define a multi-dimensional space.

In certain example embodiments, a method for modelling plywood mill performance at a mill is provided. The method may comprise: accessing a model of plywood production generated according to the method of any of the 13 previous paragraphs; gathering data relevant to the manufacture of plywood at the mill, at least some of the data including (a) a face veneer moisture content distribution measured at the mill, and (b) a core sheet moisture content distribution measured at the mill; providing at least the gathered data to the first model to determine an overall moisture content distribution for the mill; and modelling the plywood mill performance at the mill using the overall moisture content distribution and the first curve, wherein the first curve at least partially defines an area where a moisture content related error is to be expected.

In addition to the features of the previous paragraph, in certain example embodiments, the gathered data may further include environmental factors relevant to the mill, and mill press conditions.

In addition to the features of either of the two previous paragraphs, in certain example embodiments, a simulation may be run on at least some the gathered data to generate one or more expanded distributions, e.g., with the one or more expanded distributions being provided to the first model to determine the overall moisture content distribution for the mill.

In addition to the features of any of the three previous paragraphs, in certain example embodiments, a visualization of the modelled plywood mill performance may be provided, e.g., with the visualization including a representation of the overall moisture content distribution for the mill and a representation of the first curve.

In addition to the features of any of the four previous paragraphs, in certain example embodiments, an amount of overlap between a representation of the overall moisture content distribution for the mill and a representation of the first curve may be determined.

In addition to the features of the previous paragraph, in certain example embodiments, when the amount of overlap is determined to be above a predetermined threshold, an alert message indicating that an expected error rate is high may be generated and/or a parameter affecting functioning of the mill may be altered to reduce the amount of overlap to below the predetermined threshold.

In certain example embodiments a method for modelling expected plywood mill performance at a mill is provided. The method may comprise: accessing a model of plywood production generated according to the method of any of the 19 previous paragraphs; receiving data indicative of at least one prospective process parameter change for the manufacture of plywood at the mill; providing at least the received data to the first model to determine an expected overall moisture content distribution for the mill; and modelling the expected plywood mill performance at the mill using the expected overall moisture content distribution and the first curve, wherein the first curve at least partially defines an area where a moisture content related error is to be expected.

In addition to the features of the previous paragraph, in certain example embodiments, an expected effect on throughout may be determined based on an amount of overlap between the expected overall moisture content distribution and the first curve.

In addition to the features of either of the two previous paragraphs, in certain example embodiments, data indicative of a plurality of different prospective process parameter changes may be received, e.g., wherein at least the received data indicative of the plurality of different prospective process parameter changes is provided to the first model programmatically to determine a plurality of different expected overall moisture content distributions for the mill so that expected plywood mill performance is modelled in accordance with a plurality of different scenarios based on the different prospective process parameter changes.

In addition to the features of the previous paragraph, in certain example embodiments, an optimized set of process parameters may be selected based on the expected plywood mill performance for the different scenarios.

In addition to the features of any of the four previous paragraphs, in certain example embodiments, a first set of process parameters that are fixed and a second set of process parameters that are variable may be received from a user, e.g., wherein the first and second sets of parameters are provided to the first model, programmatically, to determine a plurality of different expected overall moisture content distributions for the mill so that expected plywood mill performance is modelled in accordance with a plurality of different scenarios based on the first and second sets of parameters.

In addition to the features of the previous paragraph, in certain example embodiments, the process parameters in the second set of process parameters may be variable within defined ranges.

In addition to the features of any of the 25 previous paragraphs, in certain example embodiments, the first result of interest may relate to a hardware component used in the plywood production. For instance, the component may be a dryer and/or the first result of interest may relate to moisture content following drying by the dryer.

In certain example embodiments, there is provided a non-transitory computer readable storage medium tangible storing instructions that, when executed by a processor of a computer, perform the method of any of the previous 26 paragraphs. In certain example embodiments, there is provided a system for modelling plywood production, comprising processing resources including at least one processor and a memory coupled thereto, the processing resources being configured to perform operations corresponding to the method of any of the previous 26 paragraphs.

In addition to the features of the previous paragraph, in certain example embodiments, a plurality of moisture meters may be provided, e.g., with the moisture meters being configured to provide data for at least the first and second factors.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for modelling outcomes related to a modelled attribute of composite and/or engineered wood products being produced, the method comprising:
receiving data for a plurality of factors, at least some of the factors having a numerical distribution of values;
based on the received data, developing a first model that produces a distribution modelling the attribute of the wood products being produced as a function of at least some of the factors in the plurality of factors;
predicting outcomes related to the modelled attribute using outputs from the first model and a second model, the first and second models being different from one another; and
defining a first distribution of values for the modelled attribute where the predicted outcomes match a first defined outcome with at least a first threshold probability.

2. The method of claim 1, wherein at least some of the received data is obtained from a mill where the wood products are being or will be produced.

3. The method of claim 1, wherein some of the received data is obtained experimentally independent of operation of a mill at which the wood products are being or will be produced.

4. The method of claim 1, wherein the first model is a regression model.

5. The method of claim 4, wherein the regression model includes at least one interaction term that represents an interaction between two or more of the factors in the plurality of factors.

6. The method of claim 1, wherein the second model is a Bayesian based model.

7. The method of claim 1, wherein output from the second model indicates a probability of the first defined outcome occurring, given the output from the first model.

8. The method of claim 7, wherein the first defined outcome is a moisture content related error.

9. The method of claim 1, wherein the defined first distribution of values is represented by a curve, and wherein the defining comprises aggregating inputs to the second model that produce outputs indicating that the first defined outcome are likely to occur with at least the first threshold probability.

10. The method of claim 9, wherein the curve is fit to the aggregation.

11. The method of claim 10, further comprising truncating the aggregation and/or the curve based on known attributes of the first defined outcome.

12. The method of claim 1, further comprising defining a second distribution of values for the modelled attribute where the predicted outcomes match a second defined outcome with at least a second threshold probability, the first and second defined outcomes indicating unacceptable outcomes that are different from one another, the first and second distributions of values defining a space therebetween representing acceptable outcomes.

13. The method of claim 12, wherein the first distribution of values at least partially defines a first multi-dimensional space, the second distribution of values at least partially defines a second multi-dimensional space, and a third multi-dimensional space is defined between the first and second multi-dimensional spaces, the third multi-dimensional space being the space representing acceptable outcomes.

14. The method of claim 1, further comprising:
gathering data relevant to the manufacture of wood products at a mill where the wood products are being produced;
providing at least the gathered data to the first model to determine an overall moisture content related distribution; and
modelling the mill's performance using the overall moisture content related distribution and the first distribution of values, wherein the first distribution of values at least partially defines an area where a moisture content related error is to be expected.

15. The method of claim 14, wherein the gathered data further includes environmental factors relevant to the mill, and mill press conditions.

16. The method of claim 14, further comprising running a simulation on at least some the gathered data to generate one or more expanded distributions, wherein the one or more expanded distributions are provided to the first model.

17. The method of claim 14, further comprising providing a visualization of the mill's performance, the visualization including a representation of the overall moisture content related distribution for the mill and a representation of the first distribution of values.

18. The method of claim 14, further comprising determining an amount of overlap between a representation of the overall moisture content related distribution for the mill and a representation of the first distribution of values.

19. The method of claim 18, further comprising when the amount of overlap is determined to be above a predetermined threshold, generating an alert message indicating that an expected error rate is high and/or altering a parameter affecting functioning of the mill to reduce the amount of overlap to below the predetermined threshold.

20. The method of claim 1, further comprising:
receiving data indicative of at least one prospective process parameter change for the manufacture of wood products at a mill where the wood products are being produced;
providing at least the received data to the first model to determine an expected overall moisture content related distribution for the mill; and
modelling the expected mill performance using the expected overall moisture content related distribution and the first distribution of values, wherein the first distribution of values at least partially defines an area where a moisture content related error is to be expected.

21. The method of claim 20, further comprising determining an expected effect on throughput based on an amount of overlap between the expected overall moisture content related distribution and the first distribution of values.

22. The method of claim 20, further comprising receiving data indicative of a plurality of different prospective process parameter changes,
wherein at least the received data indicative of the plurality of different prospective process parameter changes is provided to the first model programmatically to determine a plurality of different expected overall moisture content related distributions for the mill so that expected mill performance is modelled in accordance with a plurality of different scenarios based on the different prospective process parameter changes.

23. The method of claim 22, further comprising selecting an optimal set of process parameters based on the expected mill performance for the different scenarios.

24. The method of claim 20, further comprising receiving from a user a first set of process parameters that are fixed and a second set of process parameters that are variable,
wherein the first and second sets of parameters are provided to the first model, programmatically, to determine a plurality of different expected overall moisture content related distributions for the mill so that expected mill performance is modelled in accordance with a plurality of different scenarios based on the first and second sets of parameters.

25. The method of claim 24, wherein the process parameters in the second set of process parameters are variable within defined ranges.

26. The method of claim 1, wherein the first result of interest relates to a hardware component used in the wood product production.

27. The method of claim 1, wherein the modelled attribute relates to moisture,
wherein the composite and/or engineered wood products being produced are plywood products, and
wherein the first model models moisture content in produced plywood products as a function of at least some of the factors in the plurality of factors.

28. The method of claim 27, wherein a first factor in the plurality of factors is a moisture content distribution for face veneers and a second factor in the plurality of factors is a moisture content distribution for core veneers, wherein the face veneers are to be placed external to the core veneers in the plywood products being produced.

29. A non-transitory computer readable storage medium tangible storing instructions that, when executed by a processor of a computer, perform the method of claim 1.

30. A system for modelling outcomes related to a modelled attribute of composite and/or engineered wood products being produced, comprising:
processing resources including at least one processor and a memory coupled thereto, the processing resources being configured to perform operations comprising:
receiving data for a plurality of factors, at least some of the factors having a numerical distribution of values;
based on the received data, developing a first model that produces a distribution modelling the attribute of the wood products being produced as a function of at least some of the factors in the plurality of factors;
predicting outcomes related to the modelled attribute using outputs from the first model and a second model, the first and second models being different from one another; and
defining a first distribution of values for the modelled attribute where the predicted outcomes match a first defined outcome with at least a first threshold probability.
